(19) United States
(12) Patent Application Publication
(10) Pub. No.: US 2009/0322808 A1
(43) Pub. Date: Dec. 31, 2009

(54) Method and apparatus for determining real time ink volume in a printer

(75) Inventors: Joan L. Mitchell, Longmont, CO (US); Larry M. Ernst, Longmont, CO (US); Carl R. Bildstein, Superior, CO (US); Bradford O. Brooks, Longmont, CO (US)

Correspondence Address: InfoPrint Solutions/ Blakely, 1279 Oakmead Parkway, Sunnyvale, CA, 94085-4040, US

(73) Assignee: InfoPrint Solutions Company LLC

(21) Appl. No.: 12/215,978

(22) Filed: Jun. 30, 2008

(51) Int. Cl. B41J 29/38

(52) U.S. Cl. 347/7

(57) ABSTRACT

A method is disclosed. The method includes measuring a first mass of an ink container supported by a printer support device, converting the first mass to a first volume, printing a first print job, measuring a second mass of the ink container after printing the first print job and converting the second mass to a second volume.

### FIELD OF THE INVENTION

This invention relates generally to the field of ink-jet printing systems. More particularly, the invention relates to determining ink volume in printing systems.

### BACKGROUND

Currently, printing systems are dispatched without a reliable ability to accurately measure the ink used within the printing systems. Inability to determine, real-time and with precision, the amount of ink remaining in ink containers feeding high end printers causes some print jobs to be initiated without sufficient ink volume remaining to complete the print job.

Various mechanisms have implemented ink drop counting and associated algorithms to calculate and provide an estimate of ink volumes present prior to starting a print job. However, these are calculations rather than actual measurements. Many printers do not have any provision for a “fuel gauge” for ink volumes within the printer. This creates significant waste when print jobs must be repeated due to one or more ink volumes being too low to complete a job successfully.

Therefore, what is desired is a reliable method of determining, real time, ink volumes remaining within a printer to eliminate waste and time lost in reprinting jobs resulting in an overall reduction in printing costs.

### SUMMARY

According to one embodiment, an ink-jet printing system is disclosed, including a printer, a container having ink to supply to the printer and a support device to couple the container to the printer, including a measuring device to measure a continuous real-time mass of the container as the ink is supplied to the printer.

In another embodiment, a method is disclosed. The method includes measuring a first mass of an ink container supported by a printer support device, converting the first mass to a first volume, printing a first print job, measuring a second mass of the ink container after printing the first print job and converting the second mass to a second volume.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of an ink measurement system; and

FIG. 3 is a flow diagram for one embodiment of reordering print jobs based upon ink requirements.

### DETAILED DESCRIPTION

A real time ink measurement mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

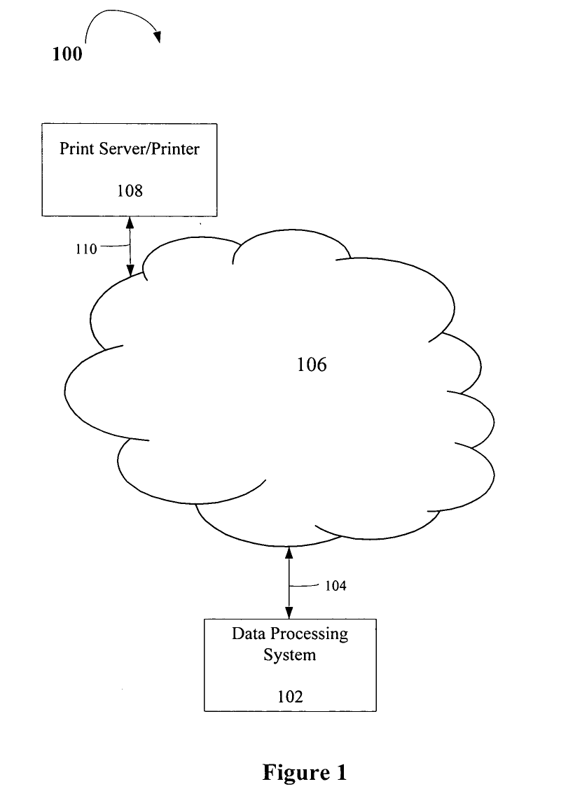

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. Data processing system 102 in accordance with the present invention preferably includes and employs the OS/2 operating system or a similar operating system and/or network drivers permitting data processing system 102 to communicate with network 106 for the purposes of employing resources within network 106.

Network 106 may be a local area network (LAN) or any other network over which print requests may be submitted to a local or (remote) printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server/printer 108 serving print requests over network 106 received via communications link 110 between print server/printer 108 and network 106. The operating system on data processing system 102 is capable of selecting print server/printer 108 and submitting requests for services to print server/printer 108 over network 106.

Print server/printer 108 includes a print queue for print jobs requested by local or (remote) data processing systems. In one embodiment, print server/printer 108 includes a print server incorporated within a high speed printer. However in other embodiments, the print server and printer may be physically separate entities.

Further, the data processing system network depicted in FIG. 1 is selected for the purposes of explaining and illustrating the present invention and is not intended to imply architectural limitations. Those skilled in the art will recognize that various additional components may be utilized in conjunction with the present invention.

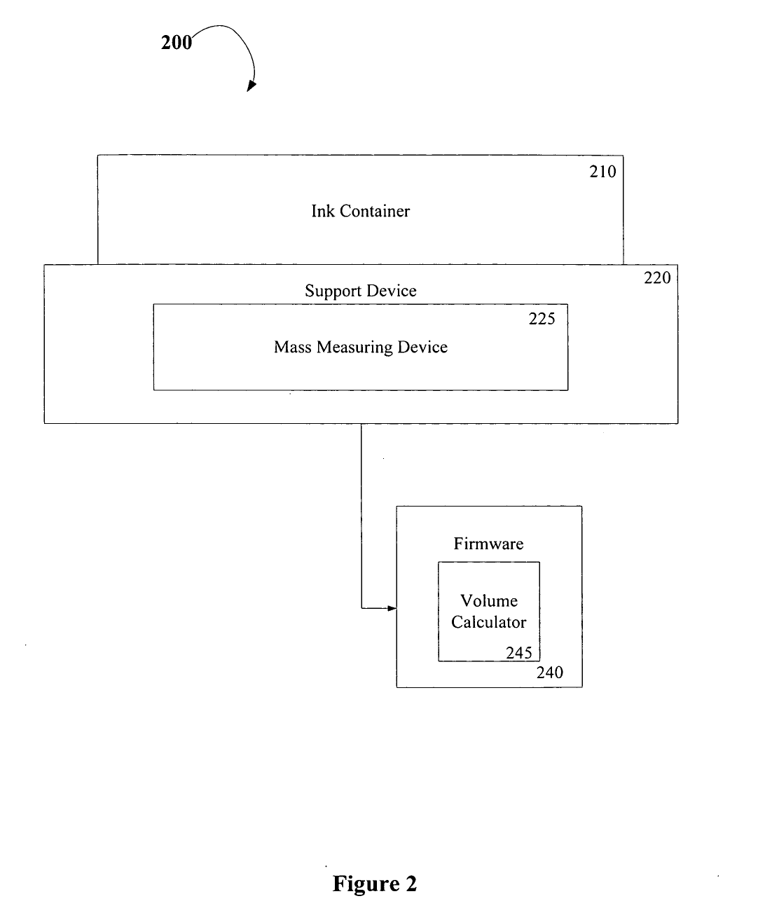

According to one embodiment, print server/printer 108 includes an ink measurement system that provides real-time measurement of the volume ink available for the processing of print jobs at print server/printer 108. FIG. 2 illustrates one embodiment of an ink measurement system 200. Ink measurement system 200 includes ink container 210 to supply ink to a print engine (not shown) at print server/printer 108.

In one embodiment, ink container 210 is a bottle. However in other embodiments, ink container 210 may be a bladder, cartridge or other type of supply container. Support device 220 couples, or cradles, ink container 210 to print server/printer 108 to provide an ink reservoir. In one embodiment, support device 220 is a shelf or platform used to support ink container 210.

According to one embodiment, support device 220 includes a mass measuring device 225 to provide a continuous real-time measurement of the mass of ink container 210. In a further embodiment, measuring device 225 is implemented using a strain gauge. However, measuring device 225 may be implemented using other mass sensing devices, such as a spring measurement device, pressure sensing piezoelectric device, etc.

In one embodiment, the mass of the ink, the mass of container 210 and the combined mass of container 210 filled with ink are used to calibrate the attachment cradle for ink container 210 prior to the activation of system 200 for real-time measurement. Once activated support device 220 operates as a smart device which allows for continuous real-time measurements of mass and mass change within ink container 210 as ink is supplied to print server/printer 108. The real-time mass measurements are transmitted to firmware 240 where a conversion to volume is performed at a volume calculator 245

In one embodiment, a continuous read-out of the volume may be displayed on a printer control screen. However, other embodiments the real-time volume calculations may be used to perform various printer controller functions. For instance, a function may be implemented to “lockout” a print job request that would demand more ink than present within print server/printer 108, as determined by the individual ink levels in one or more ink containers 210 present in the server/printer 108.

In another embodiment, a Traffic Router function may be performed to sort print job requests based upon job type and ink demand versus ink volumes available in ink containers 210 required for the job. In yet another embodiment, a function is implemented to accurately measure ink consumption during a large production run by measuring start and finishing volumes in a short trial run. Such an embodiment would allow more competitive bidding for service bureau printers. In still another embodiment, the same technique could be used to monitor waste ink collection reservoir to prevent overflow.

According to one embodiment, the real-time volume calculations may be used to re-order or re-rank printer job requests based upon ink requirements of the job and ink available within the printer. In such an embodiment firmware 240 code (or other software within server/printer 108 could allow for user selectable priorities in this feature. Because ink mass/volume is measured continuously, printer jobs could be re-ordered or re-ranked on the fly.

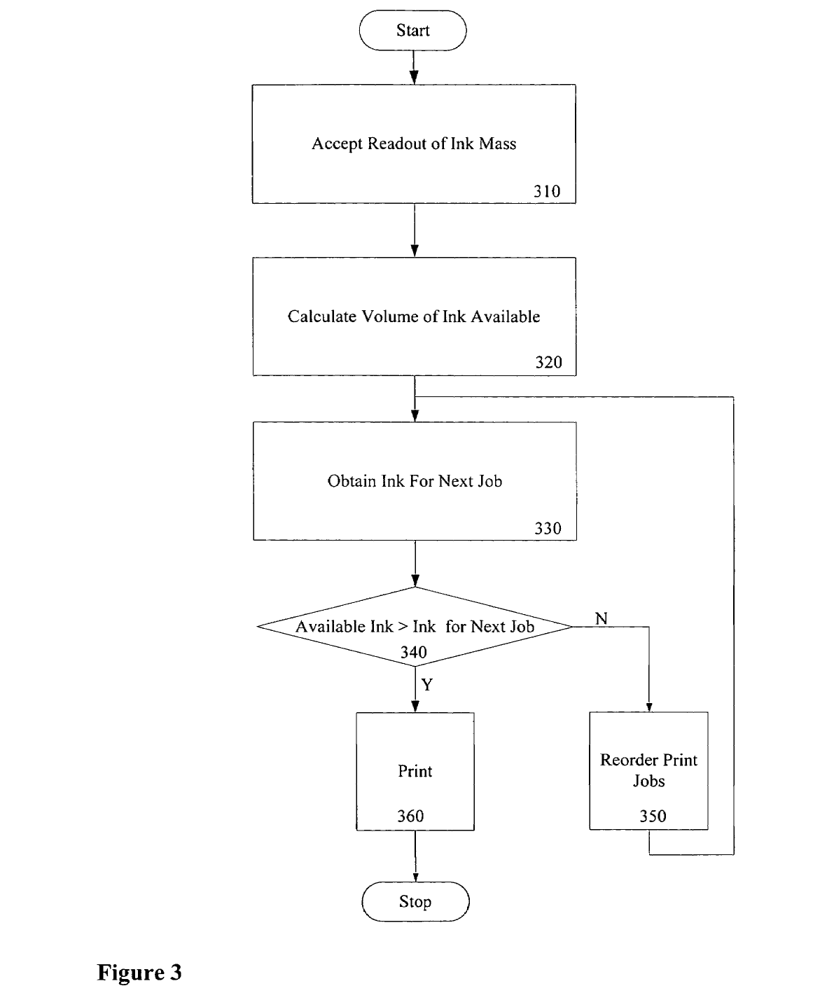

FIG. 3 is a flow diagram illustrating one embodiment of reordering print jobs based upon ink requirements. At processing block 310, firmware 240 code accepts a readout of ink mass. At processing block 320, the volume of ink available is calculated. At processing block 330, the volume of ink required to generate a current print job.

At decision block 340, there is a determination whether the calculated volume of available ink is greater than the volume of ink required to generate the current print job. If the calculated volume is less than the volume of ink required to generate the current print job, the current print job is reordered so that a subsequent print job is instead selected to be printed, processing block 350.

In one embodiment, the current job is rejected. However, in an alternative embodiment, the current print job is rescheduled further down in the print job request queue when the printing ink supply is sufficient to complete the job. Subsequently, control is returned to processing block 330 where the volume of ink required to generate the selected print job is obtained. If the calculated volume is greater than the volume of ink required to generate the next print job, the print job is printed, processing block 360.

The above-described mechanism provides a simple and reliable method of determining real time ink volumes remaining within a printer to eliminate waste and time lost in reprinting jobs. The mechanism also enables a prioritization of print jobs depending upon ink volumes present, allowing an overall reduction in printing costs to the owner, time savings to the operation staff, and significantly improved print-job throughput and turnaround times.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a local or (remote) computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. An ink-jet printing system comprising:
a printer;
a container having ink to supply to the printer; and
a support device to couple the container to the printer, including a measuring device to measure a continuous real-time mass of the container as the ink is supplied to the printer.

2. The printing system of claim 1 further comprising firmware to receive the real-time mass measurements from the measuring device and to convert the real-time mass measurements to real-time ink volume calculations.

3. The printing system of claim 2 wherein the real-time ink volume calculations are displayed at the printer.

4. The printing system of claim 2 wherein the real-time ink volume calculations are used to prevent a print job request that would demand more ink than indicated by a current ink volume calculation.

5. The printing system of claim 2 wherein the real-time ink volume calculations are used to sort print job requests based upon a job type and ink demand versus ink volumes available in the ink container.

6. The printing system of claim 2 wherein the real-time ink volume calculations are used to accurately measure ink consumption during a large production run by measuring start and finishing volumes in a short trial run.

7. The printing system of claim 2 wherein the real-time ink volume calculations are used to re-order or re-rank job printer job requests based upon ink requirements of a job and ink available within the container.

8. The printing system of claim 1 wherein the container comprises one of a bottle, bladder or cartridge.

9. The printing system of claim 1 wherein the support device comprises one of a shelf or platform.

10. The printing system of claim 1 wherein the measuring device comprises one of a strain gauge, spring measuring device or piezoelectric device.

11. A method comprising:
measuring a first mass of an ink container supported by a printer support device;
converting the first mass to a first volume;
printing a first print job;
measuring a second mass of the ink container after printing the first print job; and
converting the second mass to a second volume.

12. The method of claim 11 further comprising displaying the first and second volumes at the printer.

13. The method of claim 11 further comprising determining a volume of ink required to generate the second print job.

14. The method of claim 13 further comprising:
determining whether the second volume is greater than the volume of ink required to generate the second print job; and
selecting a third print job to be printed in place of the second print job if the second volume is less than the volume of ink required to generate the second print job.

15. The method of claim 14 further comprising printing the print job if the second volume is greater than the volume of ink required to generate the second print job.

16. An article of manufacture comprising a computer-readable medium having associated data, wherein the data, when accessed, results in a machine performing operations comprising:
measuring a first mass of an ink container supported by a printer support device;
converting the first mass to a first volume;
printing a first print job;
measuring a second mass of the ink container after printing the first print job; and
converting the second mass to a second volume.

17. The article of manufacture of claim 16 further comprising determining a volume of ink required to generate the second print job.

18. The article of manufacture of claim 17 further comprising:
determining whether the second volume is greater than the volume of ink required to generate the second print job; and
selecting a third print job to be printed in place of the second print job if the second volume is less than the volume of ink required to generate the second print job.

19. The article of manufacture of claim 17 further comprising printing the print job if the second volume is greater than the volume of ink required to generate the second print job.

20. The article of manufacture of claim 16 further comprising displaying the first and second volumes at the printer.
